(19) United States
(12) Patent Application Publication
(10) Pub. No.: US 2019/0315654 A1
(43) Pub. Date: Oct. 17, 2019

(54) Beneficiation of Inorganic Matrices with Wet, Non-Agglomerated, High-Concentration and Stable Graphite Nanoplatelets without Any Extra Measures to Disperse the Nanoplatelets

(71) Applicant: Metna Co, Lansing, MI (US)

(72) Inventor: Anagi Manjula Balachandra, Okemos, MI (US)

(73) Assignee: Metna Co, Lansing, MI (US)

(21) Appl. No.: 15/237,510

(22) Filed: Aug. 15, 2016

(51) Int. Cl. C04B 14/02; C04B 40/00; C04B 28/10; C04B 14/48; C04B 16/06; C04B 14/42; C04B 14/38; B28C 5/40; B28B 1/14; B28B 11/24

(52) U.S. Cl. CPC C04B 14/024; C04B 40/0046; C04B 28/10; C04B 14/48; B28B 11/24; C04B 14/42; C04B 14/386; B28C 5/402; B28B 1/14; C04B 16/06

(57) ABSTRACT

The present invention relates generally to beneficiation of inorganic matrices via addition of nano-materials without altering the production conditions of the inorganic matrix, and more specifically it relates to enhancement of concrete with wet graphite nanoplatelets using conventional concrete production equipment and procedures without any need for extra measures such as sonication, use of surfactants or functionalization of nanomaterials for dispersion of nanoplatelets.

### STATEMENT REGARDING FEDERALLY SPONSORED RESEARCH & DEVELOPMENT

This invention was made with U.S. government support under Contract FA9550-15-C-0012 by the U.S. Air Force. The U.S. government has certain rights in the invention.

### DESCRIPTION

### Technical Field

The present invention relates generally to beneficiation of inorganic matrices via addition of nano-materials without altering the production conditions of the inorganic matrix, and more specifically it relates to enhancement of concrete with wet graphite nanoplatelets using conventional concrete production equipment and procedures without any need for extra measures such as sonication, use of surfactants or functionalization of nanomaterials for dispersion of nanoplatelets.

### Background Art

The following is a tabulation of some prior art that presently appears relevant:

U.S. Patents

| | Kind | | |
|---|---|---|---|
| Patent Number | Code | Issue Date | Patentee |
| U.S. Pat. No. 7,666,327 | B1 | Feb. 23, 2010 | Veedu |
| U.S. Pat. No. 8,426,501 | B1 | Apr. 23, 2013 | Taha |
| U.S. Pat. No. 8,951,343 | B2 | Feb. 10, 2015 | Sadiq |
| U.S. Pat. No. 8,865,107 | B2 | Oct. 21, 2014 | Hersam |
| U.S. Pat. No. 7,824,651 | B2 | Nov. 2, 2010 | Zhamu |

U.S. Patent Application Publications

| | Kind | | |
|---|---|---|---|
| Application Number | Code | Publication Date | Applicant |
| US 20150152314 | A1 | Jun. 4, 2015 | Ramesh Muthusamy |

The large specific surface area of thin graphite nanoplatelets with about 0.3 to 300 nanometer thickness and about 1 to 300 micrometer planar dimensions produces a tendency towards clustering of the graphite nanoplatelets into three-dimensional agglomerates (particles) with micrometer-scale and larger particle size. Clustered graphite nanoplatelets are held together within the agglomerates via secondary interatomic (e.g., van der Waals) forces. Uniform dispersion of thin graphite nanoplatelets within cementitious materials during production of inorganic matrix/graphite nanoplatelet composites is challenged by the agglomeration tendency of the nanoplatelets. This challenge is addressed in laboratory by sonicating/ultrasonicating the agglomerates in a relatively large quantity of a solvent (e.g., water or water incorporating surfactants) in order to break down the clusters into individual nanoplatlets through input of intense energy and, in the presence of surfactants, simultaneously making the nanoplatelet edges and parts of their surfaces hydrophilic (U.S. Pat. No. 7,824,651B2). Sonication/ultrasonication in relatively large quantities of water, however, cannot be easily implemented in mass-scale production of cementitious materials (e.g., Portland cement concrete) using conventional industrial-scale methods of concrete batching and mixing. In these respects, preparation of graphite nanoplatelets according to the present invention uses wet nanoplatelets which have not been dried to complete their processing. In these partially processed wet nanoplatelets, water molecules mitigate secondary interatomic bonding of the nanoplatelets, and substantially simplify their dispersion in the aqueous medium of cementitious and other inorganic materials when compared with the prior art. The wet graphite nanoplatets which are subject of the present invention surprisingly do not require sonication/ultrasonication or any mechanical agitation in water, functionalization, or use of surfactants during mixing, and can be dispersed in mass-scale concrete production by simply using the conventional mixing action of concrete. The interaction between water molecules and graphite nanoplatelets significantly delays drying of the nanoplatelets which are subject of this invention, thus enhancing the shelf life of the wet, non-agglomerated graphite nanoplatelets. This simplifies their sealing requirement for preventing the loss of moisture from nanoplatelets. The moisture content of wet, non-agglomerated graphite nanoplatelets suiting convenient dispersion in inorganic matrices ranges from 50 to 95%, which is not excessive considering the relatively low dosages of nanoplatelets required in inorganic matrices, and eliminates the need for handling large quantities of water together with graphite nanoplatelets. Finally, some methods of processing graphite nanoplatelets use water as a means of delaminating graphite into thin sheets. Wet, non-agglomerated graphite nanoplatelets constitute an alternative product that can be derived in the production of dry thin graphite nanoplatelets. This wet, non-agglomerated product is thus available at costs competitive with dry thin graphite nanoplatelets. The fact that the wet, non-agglomerated graphite nanoplatelets, as an alternative product does not require any extra processing such as sonication, functionalization, or special mixing methods, to be dispersed in conventional concrete mixtures in laboratory or at industrial scale, is unexpected. This is unlike the prior art where extra measures are required for dispersion of nanomaterials in concrete. U.S. Pat. No. 7,666,327 requires sonication, use of a solvent and use of a hydrophilic cellulose-derived compound in order to disperse nanomaterials in the mixing water of cementitious materials. U.S. Pat. No. 8,426,501 requires pre-dispersion of nanomaterials in a surfactant-containing polymer with a surfactant attached to the polymer chain, and the surfactant-containing polymer non-covalently bonded to nanomaterials, in order to disperse nanomaterials in a cementitious matrix. U.S. Pat. No. 8,951,343 requires the use of surfactants and/or polyelectrolytes as well as ultrasonication to disperse nanomaterials in a special cementitious matrix. U.S. Patent Application US 20150152314 requires the use of dispersants to disperse graphite nanoplatelets in a special cementitious matrix that is a grout without coarse and fine aggregates. U.S. Pat. No. 8,865,107 requires the use of a surfactant and ultracentrifugation and ultrasonication to disperse nanomaterials in a cementitious matrix. The present invention eliminates the need for any solvent, polyelectrolyte, sonications/ultrasonication, ultracentrifugation, special mixing or special mixtures to realize a uniform dispersion of graphite nanoplatelets in cementitious materials. A normal mixing action used for cementitious materials, without the addition of any materials other than those present in a conventional cementitious mixture, are adequate for dispersion of partially processed (wet, non-agglomerated) graphite nanoplatelets in cementitious materials.

### SUMMARY OF THE INVENTION

### Technical Problem

Graphite nanoplatelets can benefit the moisture barrier, durability and other engineering properties of cemenitious materials as long as they approach uniform dispersion conditions within the cementitious matrix. The surface attraction forces over the relatively large surface areas of fully processed and dried graphite nanoplatelets, however, produce three-dimensional agglomerates which are difficult to disperse within the cementitious matrix via conventional methods of mixing cementitious materials such as concrete. Dispersion of these agglomerates requires addition of an initial step where the agglomerates are first pre-dispersed in a relatively large quantity of water via input of sonication/ultrasonication and/or mechanical energy over a period of time; surface functionalization of nanomaterials and addition of solvents and/or polyelectrolytes benefit the dispersion process. This step is followed by the use of water with dispersed nanoplatelets as the mixing water of cementitious materials. The pre-dispersion step, which consumes a fraction or all of the mixing water of cementitious materials, is difficult to implement in the industrial-scale production of concrete and other cementitious materials. In these industrial-scale production methods, raw materials such as cement, supplementary cementitious materials, aggregates, admixtures and fibers are simply added to the mixer in conjunction with water, and the normal mixing action of concrete is adequate for achieving a reasonably uniform dispersion of all ingredients within the fresh mixture. Normal mixing actions can be achieved by numerous methods currently used in concrete production for infrastructure applications, including a variety of rotational equipment such as planetary mixer, drum mixer, pan mixer, vertical axis mixer, and twin shaft mixer that is stationary or mixed on a vehicle or a manual hand mixing techniques.

### Solution to Problem

Full processing of graphite nanoplatelets varies by the type of manufacturing process. Some processes involve intercalation of graphite followed by processing in solutions which may include water. The final product of all of these processes is a dry graphite nanoplatelet powder. The particles of these powders have large specific surface areas. The surface attraction forces over the large specific surface area of nanoplatelets leads to their agglomeration. To separate the graphite nanoplatelets or to break up the agglomerations requires input of energy and solvents/surfactants/polyelectrolytes, and functionalization of nanomaterials to disperse them within cementitious materials and concrete. Some manufacturers of graphite nanoplatelets, such as XG Sciences, Inc., have found a method to modify processes that create graphite nanoplatelets in order avoid operations which produce dry graphite nanoplatelets yet maintaining the graphite nanoplatelet structure and properties. This method could be considered to be a partially processed graphite nanoplatelet when considered from the point of view of a powder product. A supply of a wet, non-agglomerated product can be obtained from such manufacturers. The direct addition of wet, non-agglomerated and highly concentrated nanoplatelets, a product that has not been subjected to operations that produce drying to concrete and cementitious materials was found surprisingly to produce, via a normal mixing action, cementitious and concrete nanocomposites with well dispersed nanomaterials without requiring the input of extra (e.g., sonication) energy, functionalization of nanomaterials, use of solvents, surfactants or polyelectrolytes, or taking any other extra measure. The interactions of water molecules with nanoplatelet surfaces prevents rapid drying of the partially processed (wet) nanoplatelets in ambient conditions. This elongates the shelf life of nanoplatelets without the need for excess sealing measures.

### Advantageous Effects of Invention

The invention enables use of processed modified (wet) graphite nanoplatelets as relatively low-cost additives which can be used for enhancement of the material properties of cementitious materials and concrete without requiring any change in conventional production of these materials. The fact that these nanomaterials can be simply added to the mix without requiring any extra measures to achieve uniform dispersion enables their direct use in industrial-scale production of concrete and cementitious materials without any need to modify these facilities. Graphite nanoplatelets are particularly effective in enhancing the barrier qualities and durability of concrete and other cementitious materials, enabling production of concrete-based infrastructure with enhanced service life and life-cycle economy with a minor added initial material cost and without any need for modification of construction methods.

### BRIEF DESCRIPTION OF DRAWINGS

Accompanying drawings help with explaining the invented beneficiation of inorganic matrices with wet, non-agglomerated, high-concentration and stable graphite nanoplatelets without any extra measures to disperse the nanoplatelets and their applications and performance. The accompanying drawings are only for the purpose of illustrating the embodiments of the invented methods, and not for the purpose of limiting the invention.

FIG. 1 shows the pavement location prepared with welded wire fabric reinforcement and flexible warm water pipes prior to placement of concrete incorporating dispersed graphite nanoplatelets.

FIG. 2 shows discharge of concrete incorporating dispersed graphite nanoplatelets from the ready-mixed concrete truck.

FIG. 3 shows spreading of concrete incorporating dispersed graphite nanplatelets.

FIG. 4 shows finishing of concrete incorporating dispersed graphite nanoplatelets.

FIG. 5 shows the finished concrete pavement incorporating dispersed graphite nanoplatelets.

FIG. 6 shows examples of the specimens prepared inside molds in field for transfer to laboratory.

FIG. 7a. sorptivity test results for plain concrete and concrete materials with different types and volume fractions of dispersed graphite nanoplatelets of 100 micrometer planar dimension and FIG. 7b sorptivity test results for plain concrete and concrete materials with different types and volume fractions of dispersed graphite nanoplatelets of 25 micrometer planar dimension.

FIG. 8a compressive strength test results for plain concrete and concrete materials with different types and volume fractions of dispersed graphite nanoplatelets of 100 micrometer planar dimension and FIG. 8b compressive strength test results for plain concrete and concrete materials with different types and volume fractions of dispersed graphite nanoplatelets of 25 micrometer planar dimension.

FIG. 9a split tensile strength test results for plain concrete and concrete materials with different types and volume fractions of dispersed graphite nanoplatelets of 100 micrometer planar dimension and FIG. 9b. split tensile strength test results for plain concrete and concrete materials with different types and volume fractions of dispersed graphite nanoplatelets with 25 micrometer planar dimension.

FIG. 10a flexural strength test results for plain concrete and concrete materials with different types and volume fractions of dispersed graphite nanoplatelets of 100 micrometer planar dimension and FIG. 10b flexural strength test results for plain concrete and concrete materials with different types and volume fractions of dispersed graphite nanoplatelets of 25 micrometer planar dimension.

FIG. 11a abrasion test results for plain concrete and concrete materials with different types and volume fractions of dispersed graphite nanoplatelets of 100 micrometer planar dimension and FIG. 11b abrasion test results for plain concrete and concrete materials with different types and volume fractions of dispersed graphite nanoplatelets with of 25 micrometer planar dimension.

FIG. 12 shows an scanning electron microscopy (SEM) image of concrete incorporating 0.05 vol. % of graphite nanoplatelets with 100 micrometer average planar dimension.

FIG. 13 shows an SEM image of concrete incorporating 0.05 vol. % of graphite nanoplatelet with 100 micrometer average planar dimension.

FIG. 14 shows an SEM image of concrete incorporating 0.05 vol. % of graphite nanoplatelets with 100 micrometer average planar dimension (with the corresponding EDS images shown in FIG. 15).

FIG. 15 shows energy dispersive spectroscopy (EDS) images of concrete incorporating 0.05 vol. % of graphite nanoplatelets with 100 micrometer average planar dimension (with the corresponding SEM image shown in FIG. 14).

### DESCRIPTION OF EMBODIMENTS

The disclosure generally relates to cementitious binder compositions, related concrete compositions, and related methods. The cementitious binder incorporates graphite nanoplatelets which are added to the mix in wet, non-agglomerated and high-concentration condition. Conventional cementitious binder compositions and normal mixing actions are adequate for uniform dispersion of the graphite nanoplatelets within the cementitious binder. The cementitious binder can be combined with aggregate and used to form corresponding (cured) concrete compositions.

Rapid deterioration of the concrete-based infrastructure carries major economic and environmental consequences. In addition, the trend towards use of higher-performance concrete has created demands for enhancing the toughness, bond strength to reinforcing steel and other properties of high-performance concrete in order to make effective use of their desired qualities. Graphite nanoplatelets, when dispersed in cementitious materials and concrete, act as multifunctional additives which enhance various mechanical, barrier and durability characteristics of concrete as well as its bond strength to reinforcing steel and discrete fibers.

Early efforts to use nanomaterials in cementitious binders and concrete encountered the challenge of overcoming the van der Waals attraction over the large specific surface area of nanomaterials in order to uniformly disperse nanomaterials and realize their reinforcement potential in cementitious binders. In order to address this challenge, past efforts have resorted to methods developed for uniform dispersion of nanomaterials in polymer matrices. These efforts include ultrosonication of nanomaterials which are added at relatively low dosages to solvents (water in the case of cementitious binders), and functionalization of nanomaterials. These measures, however, involve changes in the production process of cementitious binders and concrete which are not easily scalable, and have not been adopted in industrial-scale production of concrete. The high cost of nanomaterials which have been subject of most research activities concerned with their use in concrete, primarily carbon nanotubes, has also been an important drawback. The unexpected finding (which is the basis of this invention) that partially processed graphite nanoplatelets which are wet and non-agglomerated can be thoroughly dispersed in diverse concrete materials using conventional mixing actions overcomes all the obstacles against industrial-scale use of nanomaterials in cementitious binders and concrete. The multi-faceted benefits of nanoplatelets in concrete, and their relatively low cost make them viable additives which can be simply added, in wet, non-agglomerated form, to concrete mixtures similar to other admixtures without requiring any adjustment of the mix proportions, sequence of addition of materials to mixer, or mixing action.

The combination of micro-scale planar dimensions of nanoplatelets with their nano-scale thickness as well as the chemically active edges of nanoplatelets are particular geometric and chemical features which could explain the surprising finding that, in a partially processed form where there are wet and non-agglomerated, the nanoplatelets can be conveniently dispersed in simple concrete mixtures without any adjustment of the mix materials and proportions or the mixing action. These same features together with the high elastic modulus of graphite nanoplatelets provide it with the capability to make multi-faceted contributions towards the barrier, durability, physical and mechanical characteristics of concrete.

Graphite nanoplatelets with planar dimensions of 1 to 300 micrometer and thickness of 3 to 300 nanometer, when dispersed within cementitious binder and concrete at 0.03 to 0.3 volume percent, produce improvements in moisture barrier qualities, durability, toughness, impact resistance, abrasion resistance and dimensional stability. Key improvements in moisture barrier qualities are realized because closely spaced graphite nanoplatelets produce tortuous transport paths into cementitious binders and concrete; enhanced barrier qualities are key to realizing improved durability characteristics with the addition of graphite nanoplatelets to cementitious materials and concrete. Closely spaced nanoplatelets are also effective in arresting microcracks; the relatively large planar dimensions and high specific surface area of nanoplatelets also enhance their microcrack and crack arrest capabilities and frictional pullout at relatively high stress levels. These phenomena benefit the damage and deterioration resistance of cementitious materials and concrete under mechanical loads and weathering effects.

While graphite nanoplatelets that are dispersed within cementitious binders and concrete benefit various aspects of material performance, their effects could be nullified or even reversed if they are not well dispersed are present within the matrix in clustered form. Special measures are required for overcoming the secondary bonds developed over the large specific surface are of nanomaterials in order to disperse them in different inorganic or organic matrices. These measures are not scalable and economically viable.

In order to overcome drawbacks associated with clustering of graphite nanoplatelets without resorting to costly measures that are not scalable, graphite nanoplatelets are used in a form that does not include drying of the particles and the resultant powder. In this condition, graphite nanoplatelets exist in wet and non-agglomerated form, with water molecules separating the nanoplatelets and mitigating the formation of secondary bonds between their surfaces. These weakened secondary bonds between these wet, non-agglomerated graphite nanoplatelets can be broken by the regular mixing action of concrete without the need for input of sonication energy to relatively low-concentration of nanoplatelets, use of surfactants and functionalization of nanoplatelets, noting that these measures are not easily scalable and have cost implications which compromise commercial viability of the approach. The relatively high concentration of nanoplatelets in wet and non-agglomerated condition, and the relatively low dosages of nanoplatelets required in cementitious materials and concrete enable use of nanoplatelets similar to various chemical admixtures which are introduced into concrete as solutions or suspensions, and do not require major adjustments in water content of the concrete mix. Various mixing actions commonly used for production of cementitious materials and concrete are adequate for dispersion of nanoplatelets. Broad categories of mix designs for cementitious materials and concrete are also compatible with, and benefit from, the addition of wet, non-agglomerated graphite nanoplatelets. The bound condition of water in wet, non-agglomerated graphite nanoplatelets slows down the rate of moisture loss, and improves their shelf life without resorting to costly sealing measures.

The dispersion of graphite nanoplatelets in cementitious binders and concrete offers, besides benefits resulting from its physical presence in hardened material, nucleation sites which provide for formation of a more uniform structure of hydrates within the binder volume. This effect of nanoplatelets benefits the structure and properties of cementitious binders and concrete.

### Graphite Nanoplatelets

Graphite nanoplatelets are a class of carbon nanomaterials with nanometer-scale thickness and micrometer-scale planar dimensions. Each nanoplatelet comprises multiple graphene sheets; each thickness is 3 to 300 nanometer, and each planar dimension is 1 to 300 micrometer. The planar geometry and nanometer-scale thickness of nanoplatelets combined with the high stiffness and strength, and strong barrier qualities perpendicular to the planar surfaces of graphene sheets provide graphite nanoplatelets with a desired balance of geometric and engineering properties for use as inclusions which render multi-faceted benefits when dispersed at relatively low dosages in inorganic binders. The relatively active edges of graphite nanoplatelets benefits their dispersion and interfacial interactions within binders. The combination of the geometric and surface attributes of graphite nanoplatelets facilitates their dispersion, when the nanoplatelets are used prior to drying when water molecules separate the individual nanoplatelets (which is subject of this invention), in the aqueous media of fresh hydraulic binders using the conventional methods used for mixing of these binders without the need for extra measures such as ultrasonication or special surface functionalization of nanoplatelets. This surprising finding is a distinct advantage of graphite nanoplatelets, which distinguishes them from other nanomaterials such as carbon nanotubes and nanofibers.

Graphite nanoplatelets are used in this invention in wet, non-agglomerated form, which facilitates their dispersion in inorganic matrices. The moisture content of wet, non-agglomerated graphite nanoplatelets ranges from 15 to 95% by weight; this form of nanoplatelets is an alternative product produced as an option of manufacturing the final product that is dry graphite nanoplatelets. Graphite nanoplatelets are used in cementitious binders at 0.05 to 5 vol. %. The use of wet, non-agglomerated graphite nanoplatelets enables their dispersion in cementitious binders and concrete using simply the normal mixing action of cementitious binders and concrete without taking any extra measures. These mixing actions can be achieved with methods within the current industry infrastructure.

### Cementitious Binder

In one aspect, hydraulic cementitious binders are used as the matrix within which the graphite nanoplatelets are dispersed. Hydraulic cements provide the characteristic feature of hardening through reaction with water. Examples include hydraulic cements with the following primary constituents: calcium silicate, calcium aluminosilicate, alkali aluminosilicate, calcium aluminate, calcium oxide, calcium aluminosulfate, and combinations thereof. The hydraulic cement is Portland cement, Portland-limestone cement, Portland-slag cement, Portland-pozzolan cement, ternary blended cement, general use cement, high early strength cement, moderate sulfate resistance cement, high sulfate resistance cement, moderate heat of hydration cement, low heat of hydration cement, masonry cement, calcium aluminate cement, calcium sulfoaluminate cement, aluminosilicate-based cement, shrinkage compensating cement, gypsum, lime, and combinations thereof. Reactions of these constituents with water produce solid hydrates which render binding effects. These hydraulic cementitious binders can be prepared with different water-to-solid ratios, and can be refined through addition of a number of chemical, mineral and polymer admixtures which tailor different characteristics such as fresh mix rheology, time of setting, hardened material shrinkage, impermeability, durability and other characteristics. The hydraulic cementitious binders can also be tailored through addition of fibers with millimeter- to micrometer-scale diameter and centimeter- to millimeter-scale length for enhancement of crack resistance, tensile and flexural strength, ductility, energy absorption capacity, fatigue life and fire resistance.

### Concrete Compositions

In another aspect, the disclosure relates to a concrete composition including: (a) the hydraulic cementitious binder composition according to any of the various disclosed embodiments; (b) graphite nanoplatelets dispersed within the hydraulic cementitious binder; and (c) (concrete) aggregates.

In another aspect, the disclosure relates to a cured concrete composite composition including: (a) a matrix including a hydration reaction products of water and the cementitious binder composition according to any of the various disclosed embodiments; (b) graphite nanoplatelets dispersed within said matrix; and (c) aggregates distributed throughout the matrix; and (d) optionally one or more additives selected from the group consisting of chemical additives, mineral additives, polymer additives, coloring additives, fibers, and combinations thereof is added to the mix prior to, during and after the addition of other mix ingredients, or during mixing. Optionally 5% to 75% by weight of hydraulic cement is replaced with coal ash, ground granulated blast furnace slag, silica fume, natural pozzolan, metakaolin, calcined clay, biomass ash, and combinations thereof.

In a refinement, the aggregate is selected from the group consisting of crushed stone, gravel, sand, light-weight aggregates, heavy-weight aggregates, synthetic particles, recycled particles, and combinations thereof. The aggregate can be classified/selected according to an aggregate characteristic size, which can correspond, for example, to the largest, median, or smallest size particle in the aggregate particle size distribution, such as 37.5 mm (1.5 in sieve passing), 25.0 mm (1 in), 19.0 mm (0.75 in), 12.5 mm (0.5 in), 9.5 mm (0.375 in), 4.75 mm (No. 4), 2.36 mm (No. 8), 1.18 mm (No. 16), 0.60 mm (No. 30), 0.30 mm (No. 50), 0.15 mm (No. 100), 0.075 mm (No. 200), or ranges there between, based on standard sieve sizes/techniques. The aggregate generally includes a combination of sand (group of fine aggregates) with maximum particle size less than 4.75 mm and stone/gravel (coarse aggregate) with maximum particle size more than 4.75 mm. The aggregate suitably is present in an amount ranging from about 25 wt. % to about 1000 wt. % relative to the cementitious binder (e.g., at least about 50%, 100%, 200%, 300%, or 400% and/or up to about 200%, 300%, 400%, 500%, 600%, or 800% by weight relative to the cementitious binder). Such amounts can apply to an anhydrous concrete composition, a hydrated concrete composition (e.g., pourable mixture to be applied to a substrate), and/or to a cured concrete composition.

### Cured Compositions

In another aspect, the disclosure relates to method for curing a cementitious binder Composition incorporating dispersed graphite nanoplatelets, the method including: (a) applying a cementitious binder composition incorporating dispersed graphite nanoplatelets according to any of the various disclosed embodiments (e.g., further including water in the binder composition) to a substrate or other surface; and (b) curing the cementitious binder composition incorporating graphite nanoplatelets for a selected period, thereby forming a cured cement-based composition including a cementitious matrix as a hydration reaction product of the cementitious binder composition and the water therein, with graphite nanoplatelets dispersed within the matrix volume. In a refinement, (i) the cementitious binder composition incorporating dispersed graphite nanoplatelets is in the form of a concrete composition further including aggregates; and (ii) curing the concrete composition for the selected period forms a cured concrete composition including the cementitious matrix incorporating dispersed graphite nanoplatelets and the aggregates embedded within the cementitious matrix.

The surfaces/substrates for application are not particularly limited, and can include any solid surface such as ground or a compacted base (e.g., for laying a road outside, or a building floor, or footing), formwork (e.g., for construction of wall, beam, column, or other structural building element), another cured cement/concrete surface (e.g., for repair, forming, or creating a multi-layered structure in road, building, or other context). The applied area can further include one or more reinforcing structures such as continuous bars (e.g., steel, other metal, or composite material) and discrete fibers with 0.1 to 5000 micrometer diameter and length-to-diameter ratio of 10 to 1000 of (e.g., steel, glass, polypropylene, nylon, polyvinyl alcohol, Kevlar, or carbon) added to the mix prior to, during and after the addition of other mix ingredients or during mixing with a total fiber volume that is 1 to 100 times volume of the graphite nanoplatelets. Curing can be accomplished in the presence of moisture or in sealed condition at ambient or elevated temperature. The selected period for curing can be at least and/or up to 1, 2, 3, 5, 7, 14, or 28 days prior to putting the cured composition into normal use such as a road, floor, overlay, patch, structural element, or substrate for further cement/concrete application/curing.

The cured cement-based composition and/or the cured concrete composite composition incorporating dispersed graphite nanoplatelets according to the disclosure can be characterized in terms of their relative strength, moisture sorption resistance, chloride diffusion resistance, durability, and/or dimensional stability.

### EXAMPLES

The following examples illustrate the disclosed compositions and methods, but they are not intended to limit the scope of any claims thereto.

### Example 1

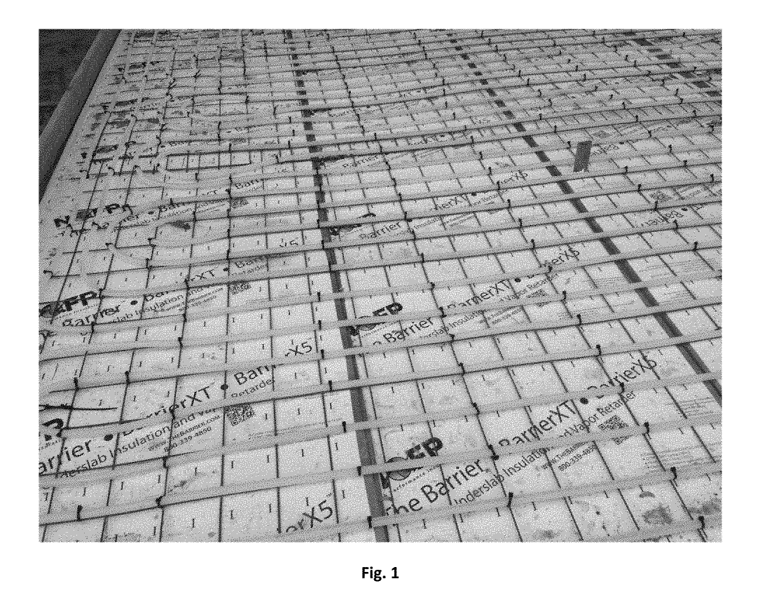

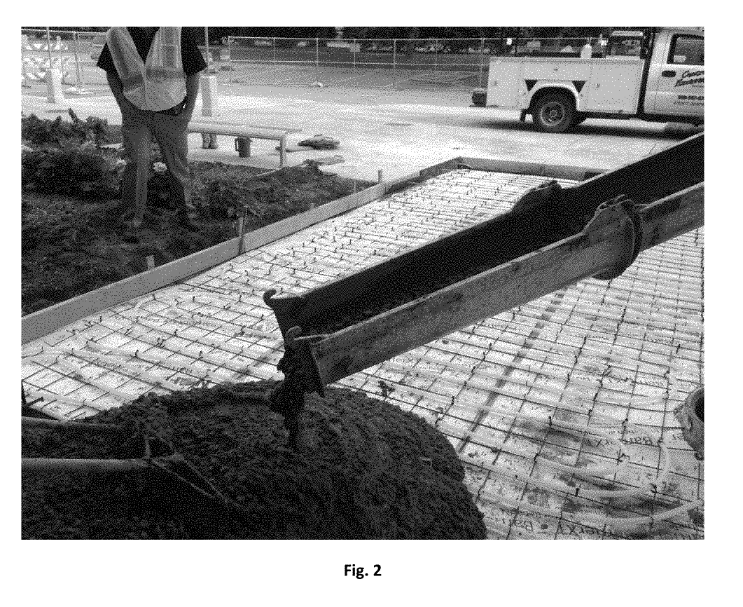

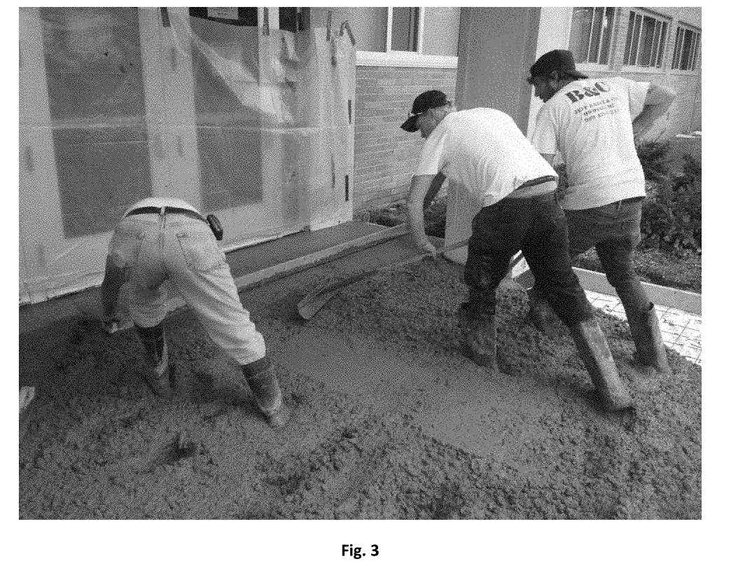

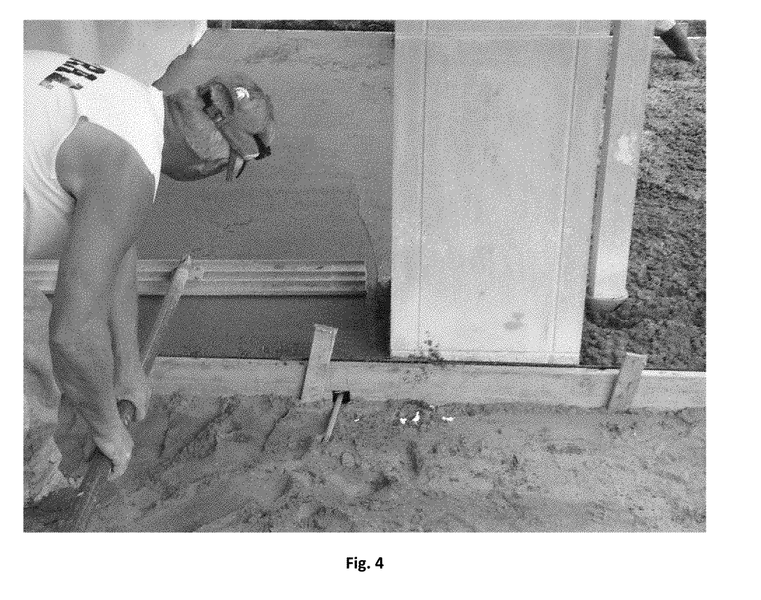

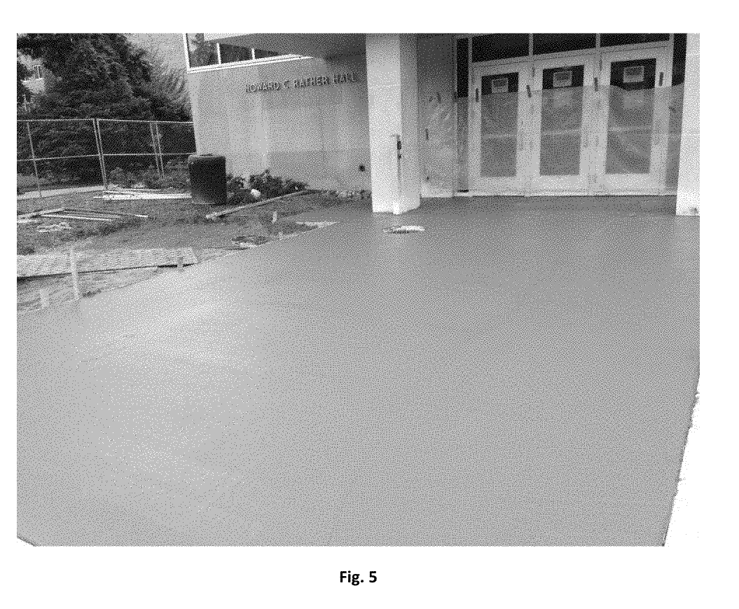

Wet, non-agglomerated graphite nanoplatelets with mean planar dimension of about micrometer and mean thickness of about 5 nanometer were added to normal-strength concrete prepared in a ready-mixed concrete truck. A total of 8 cubic yards of concrete was prepared with 0.1 vol. % graphite nanoplatelet. The wet, non-aggomerated graphite nanoplatelets had 87.5 wt. % moisture content. The total weight of solid nanoplatlets added to each cubic yard of concrete was 1.69 kg. This required the addition of 15.52 kg of wet, non-agglomerated graphite nanoplatelets to each cubic yard of concrete. The normal strength concrete matrix comprised cement:coarse aggregate (crushed limestone with 25 mm, 1 inch, maximum particle size):fine aggregate (natural sand):water at 1:3.06:2.32:0.45 weight ratios. The water content was reduced to compensate for the water content of wet, non-agglomerated graphite nanoplatelets. This concrete mix also incorporated a low-range water reducer at 0.06% by weight of cement. Eight cubic yards (nearly 16 tons) of this concrete was produced. Wet, non-agglomerated graphite nanoplatelets were added first to the empty truck. Subsequent addition (batching) of materials in the ready-mixed concrete plant and mixing in the truck was performed followed conventional methods of preparing normal-strength concrete. This procedure involved: (i) adding of 80% of water and water-reducer, followed by adding the wet, non-agglomerated graphite nanoplatlets and then all dry ingredients and the remainder of water while the mixer was running at slow rotational speed; and (ii) mixing in the ready-mixed concrete truck at fast rotational speed for about 5 minutes (accounting for about revolutions). The mixed concrete incorporating graphite nanoplatelets was then shipped to the job site which was about 16 km (10 miles) away from the mixing plant. A heated pavement was made with the normal-strength concrete incorporating dispersed graphite nanoplatelet. This concrete pavement incorporated welded wire fabric reinforcement as well as flexible plastic pipes which will run warm water through the pavement after it has been placed and cured for the purpose of melting snow and ice on the pavement surface in winter. FIG. 1 shows the prepared site for placing concrete incorporating dispersed graphite nanoplatelets, with flexible warm water pipes and welded wire fabric reinforcement placed prior to casting of concrete. Concrete with graphite nanoplatelets was discharged from truck (FIG. 2), spread (FIG. 3) and finished (FIG. 4) using conventional techniques without the need for any adjustment of common practices and time schedules. Fresh concrete incorporating graphite nanoplatelets exhibited desired workability, and could be handled in field similar to normal concrete. FIG. 5 shows the appearance of the finished concrete pavement incorporating graphite nanoplatelets, which looks similar to normal concrete, except for a slightly darker color.

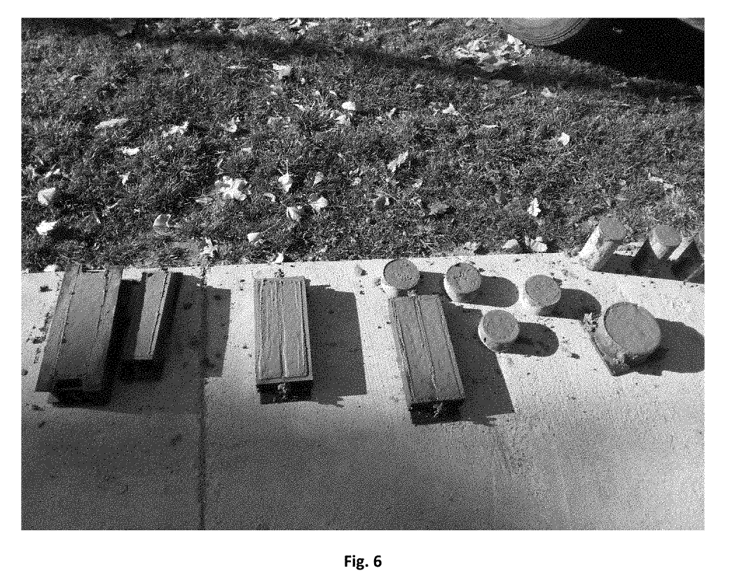

Similar field projects were also performed, with similar degrees of success, using 0.05 vol. % graphite nanoplatelets of 100 micrometer planar dimension, 0.2 vol. % of graphite nanoplatelets of 25 micrometer planar dimension, and 0.1 vol. % of graphite nanoplatelets of 25 micrometer planar dimension. Specimens were prepared in field from concrete materials produced in ready-mixed concrete trucks. The normal-strength concrete mix design (without and with different volume fractions of graphite nanoplatelets) was slightly different for graphite nanoplatelets of 25 micrometer planar dimension. This normal-strength concrete matrix comprised cement:coarse aggregate (crushed limestone with 25 mm, 1 inch, maximum particle size):fine aggregate (natural sand):water at 1:3.18:2.32:0.44 weight ratios. The water content was reduced to compensate for the water content of wet, non-agglomerated graphite nanoplatelets. FIG. 6 shows some of the specimens prepared in field for transfer to laboratory.

### Example 2

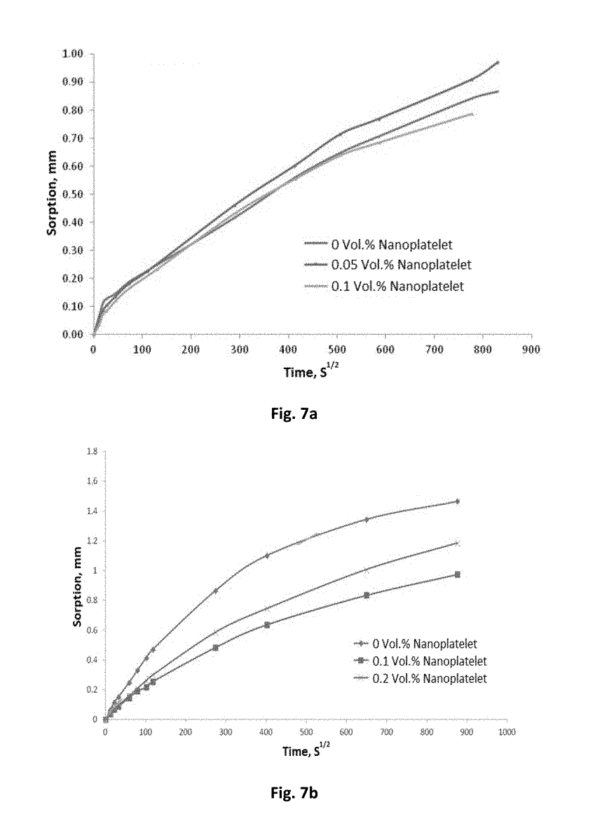

The specimens prepared in previous example from ready-mixed concrete trucks, which covered plain normal-strength concrete as well as concrete with 0.05 to 0.2 vol. % of graphite nanoplatelets of 25 to 100 micrometer planar dimensions, were transferred to laboratory, kept inside molds in sealed condition at room temperature for 24 hours, demolded and immersed in lime-saturated water until the test age of 28 days. As described earlier, graphite nanoplatelets were added directly to the ready-mixed concrete truck in wet, non-agglomerated form, and were dispersed within the fresh concrete mix using the normal mixing action of the truck without taking any extra measures. The following tests were performed on cured concrete specimens: sorptivity (ASTM C1585), compression (ASTM C39), split tension (ASTM C496), flexure (ASTM C78), and abrasion resistance (ASTM C779). The test results (mean values and 95% confidence intervals) are presented in FIGS. 7 through 11. The test data presented in FIG. 7a indicates that graphite nanoplatelets with 100 micrometer planar dimension are not effective (at the volume fractions considered here) in reducing the moisture sorptivity of concrete. FIG. 7b, on the other hand, indicates that graphite nanoplatelets of 25 micrometer planar dimension can reduce the moisture sorptivity of graphite nanoplatelets. When compared with 0.2 vol. %, 0.1 vol. % of graphite nanoplatelets produce a more significant reduction of moisture sorptivity. This could indicate that 0.2 vol. % is beyond an optimum volume fraction for thorough dispersion of graphite nanoplatelets in normal-strength concrete mixtures using the materials and methods which are subject of this invention. At 0.1 vol. %, graphite nanoplatelets of 25 micrometer planar dimension reduce the moisture sorptivity of concrete by about 40%.

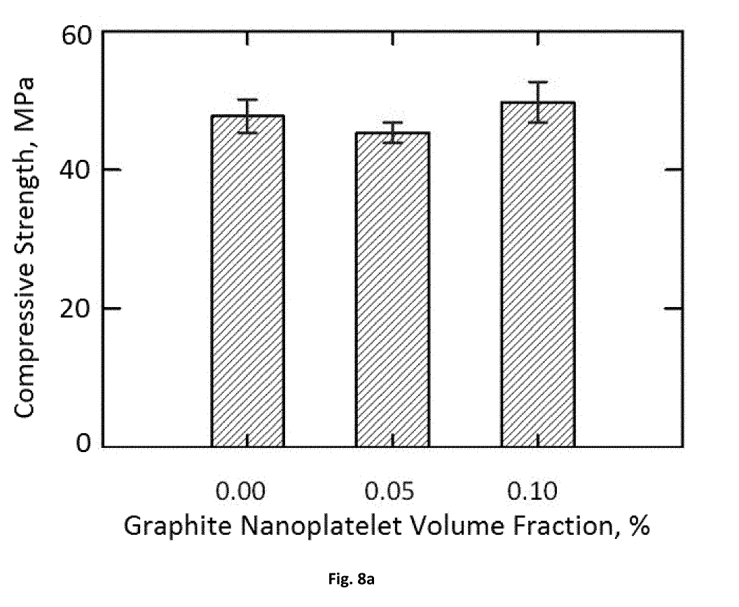

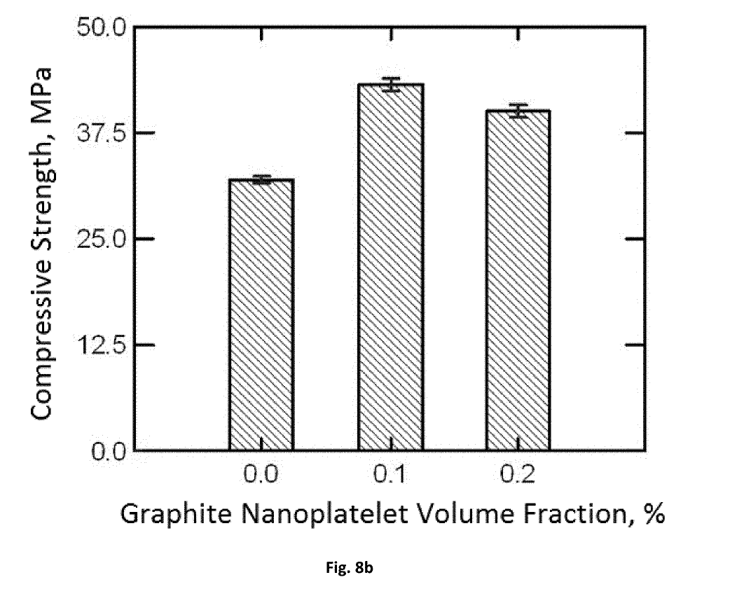

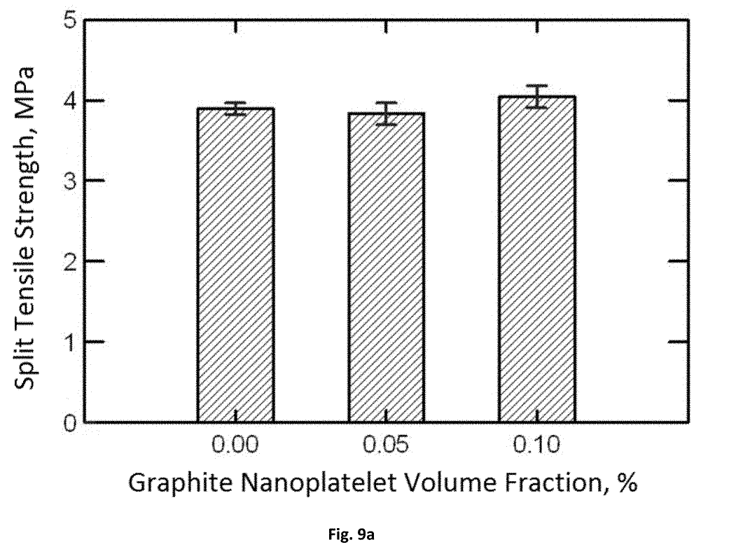

The compressive strength test results presented in FIG. 8a (mean values and 95% confidence intervals) indicate that graphite nanoplatelets with 100 micrometer planar dimensions do not affect the compressive strength of normal-strength concrete within the ranges of nanoplatelet volume fraction considered here. The test data presented in FIG. 8b, however, indicate that graphite nanoplatelets at 0.1 to 0.2 vol. % can produce some gain in the compressive strength of normal-strength concrete.

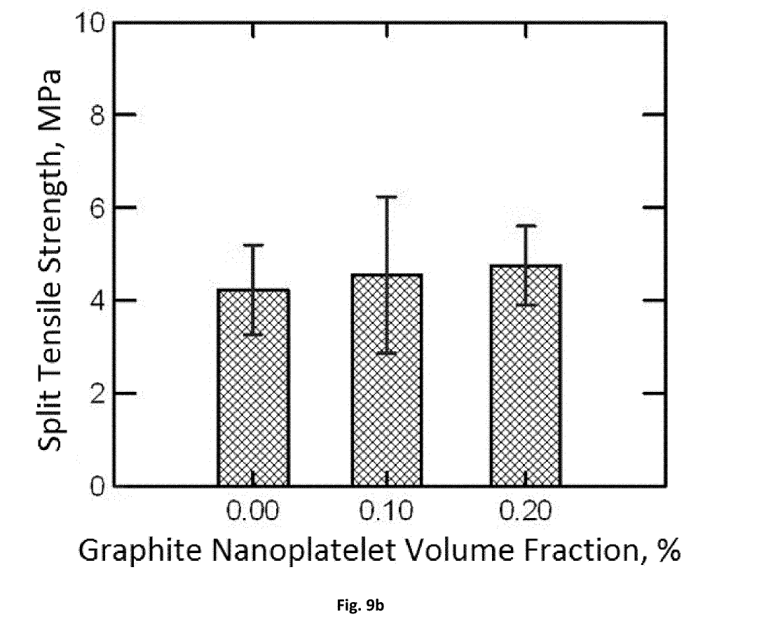

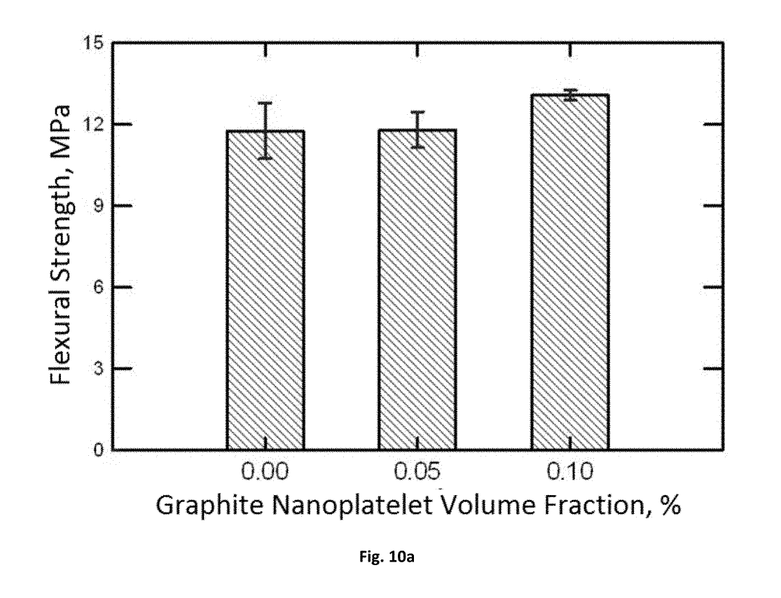

The split tension test data presented in FIG. 9 suggest that any contribution of graphite nanoplatelets towards increasing the split tensile strength of concrete is minor, and statistically insignificant.

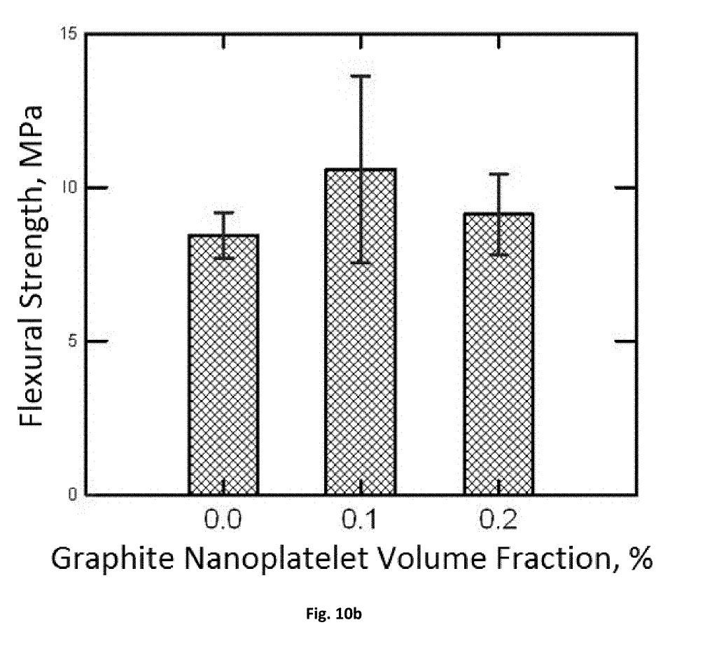

The flexural strength test results presented in FIG. 10 indicate that 0.1 vol. % of graphite nanoplatelets with either 100 or 25 micrometer planar dimension produce measurable gains in flexural strength. In light of the statistical variations in flexure test results, however, these gains are not statistically significant.

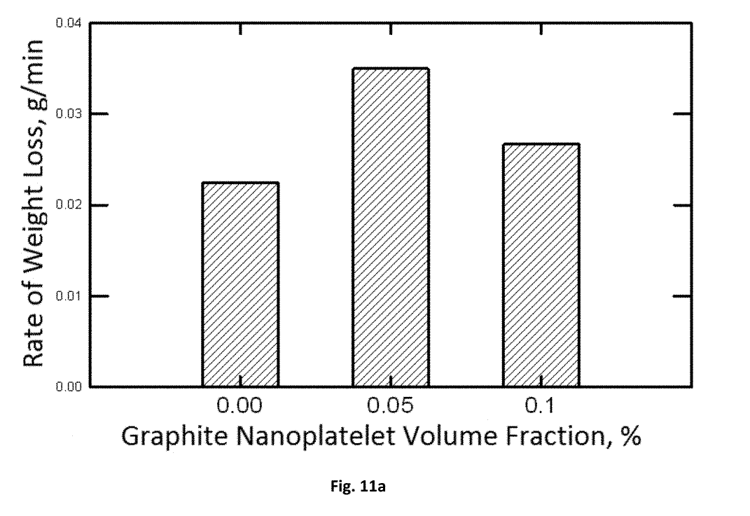

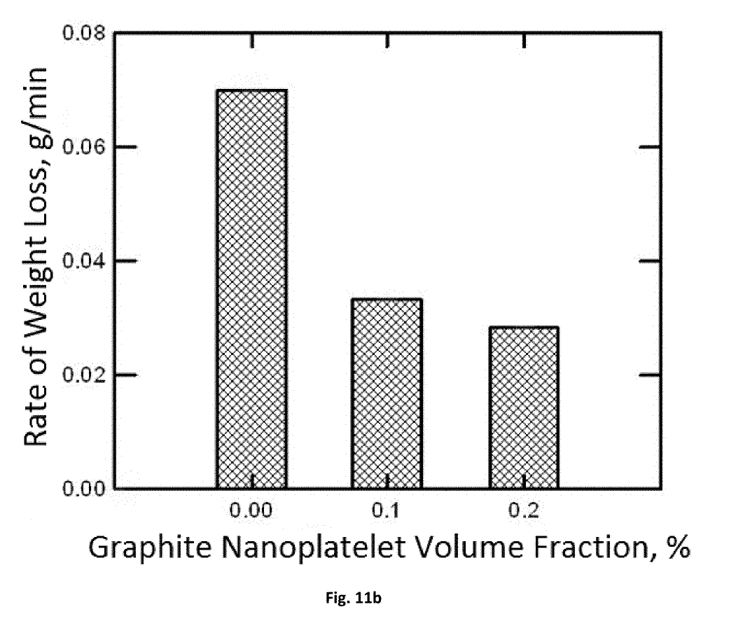

The abrasion test results summarized in FIG. 11 suggest that graphite nanoplatelets of 100 micrometer planar dimension (FIG. 11a) are not effective in reducing the abrasion weight loss of concrete. Graphite nanoplatelets of 25 micrometer planar dimension, on the other hand, significantly reduce the abrasion weight loss of concrete at all volume fractions considered here.

### Example 3

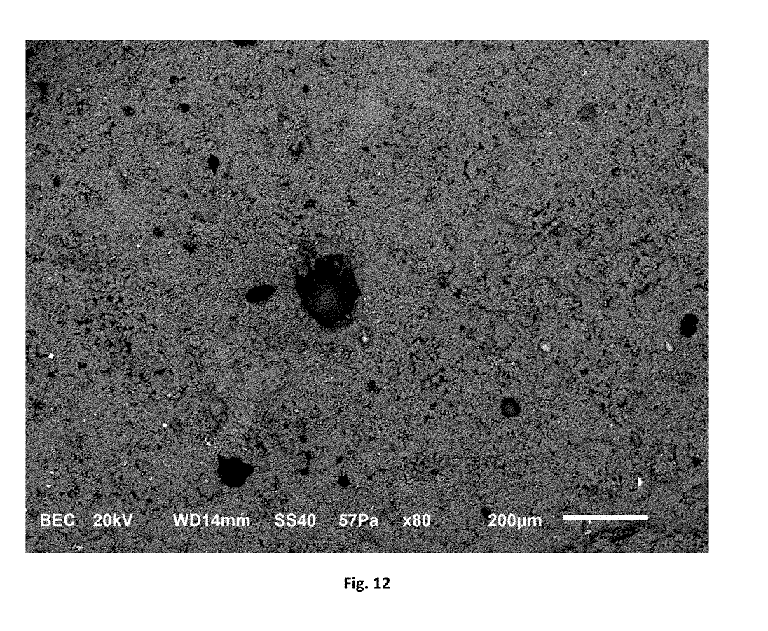

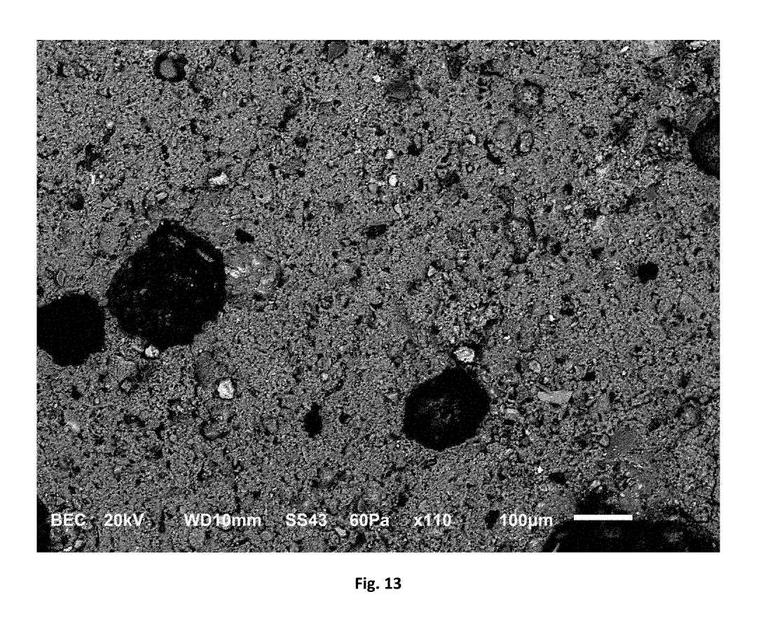

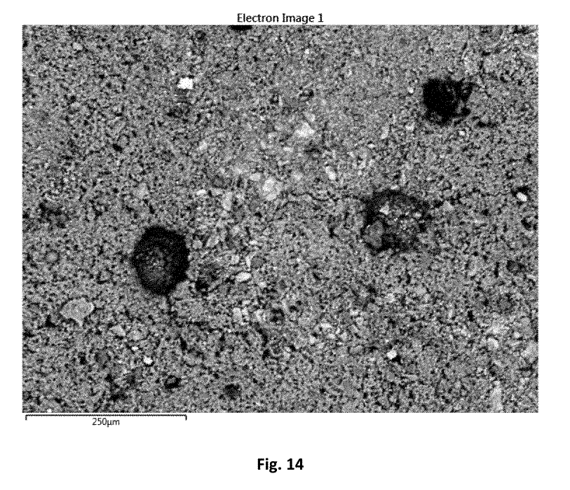

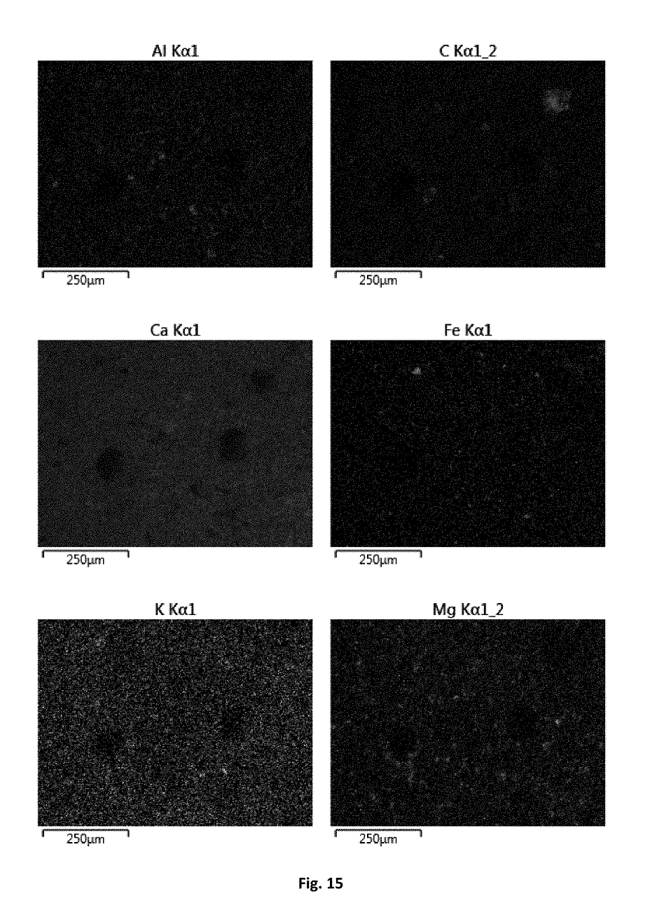

Specimens of concrete materials produced in ready-mixed concrete truck, to which wet, non-agglomerated graphite nanoplatelets were added, were subjected to scanning electron microscopy (SEM) and energy dispersive spectroscopy (EDS). These studies were undertaken to verify that wet, agglomerated graphite nanoplatelets can be dispersed in normal concrete materials via normal mixing action without requiring any extra measures. FIGS. 12 and 13 present typical SEM images, at different magnifications, of concrete surfaces incorporating 0.05 vol. % of graphite nanoplatelets with 100 micrometer average planar dimension. The dark segments of these images are, as verified using EDS, graphite nanoplatelets which are well dispersed within concrete. No agglomeration of graphite nanoplatelets is observed in SEM images. FIGS. 14 and 15 show typical SEM and the corresponding EDS images of the surface of a concrete specimen with 0.05 vol. % of graphite nanoplatelets with 100 micrometer average planar dimension. The EDS images shown in FIG. 15 indicate that the darker areas where graphite nanoplatelets are assumed to occur are rich in carbon and poor in other elements found in cement hydrates. This finding indicates that the darker areas observed in FIGS. 12 through 14 are the dispersed graphite nanoplatelets. The dimensions of these darker regions are also consistent with those expected for graphite nanoplatelets of 100 micrometer average planar dimension.

What is claimed is:

1. A method of producing a fresh cementitious material with dispersed graphite nanoplatelets, the method comprising:
(a) Adding graphite nanoplatelets with 0.3 to 300 nanometer thickness and 3 to 300 micrometer planar dimensions to a mixer in wet, non-agglomerated state with 50 to 95% by weight of water molecules which occur in physically adsorbed state on the surfaces of said nanoplatelets, and hinder their agglomeration via secondary bonding;
(b) Adding to said mixer water and hydraulic cement with a total volume that is 50 to times the solid volume of said graphite nanoplatelets, and with water-to-cement weight ratio of 0.1 to 0.9; and
(c) Mixing of water, hydraulic cement and graphite nanoplatelets at 3 to 300 rounds per minute rotational speed for 1 to 45 minutes.

2. The method of claim 1, wherein the mixer is one of planetary mixer, drum mixer, pan mixer, vertical axis mixer, and twin shaft mixer that is stationary or mixed on a vehicle, or a manual mixing method.

3. The method of claim 1, wherein the hydraulic cement is Portland cement, Portland-limestone cement, Portland-slag cement, Portland-pozzolan cement, ternary blended cement, general use cement, high early strength cement, moderate sulfate resistance cement, high sulfate resistance cement, moderate heat of hydration cement, low heat of hydration cement, masonry cement, calcium aluminate cement, calcium sulfoaluminate cement, aluminosilicate-based cement, shrinkage compensating cement, gypsum, lime, and combinations thereof.

4. The method of claim 1, wherein 5% to 75% by weight of hydraulic cement is replaced with coal ash, ground steel slag, silica fume, natural pozzolan, metakaolin, calcined clay, biomass ash, and combinations thereof.

5. The method of claim 1, wherein one or more additives selected from the group consisting of chemical additives, polymer additives, mineral additives and coloring additives is added to the mix prior to, during and after the addition of other mix ingredients, or during mixing.

6. The method of claim 1, wherein one or more aggregates selected from the group of fine aggregates with maximum particle size less than 4.75 mm and coarse aggregates with maximum particle size more than 4.75 mm is added to the mix prior to, during and after the addition of other mix ingredients, or during mixing, with a total aggregate weight that is 0.1 to times the weight of hydraulic cement.

7. The method of claim 1, wherein one or more fibers selected from the group consisting of steel, polymer, glass and carbon fibers with 0.1 to 5000 micrometer diameter and length-to-diameter ratio of 10 to 1000 is added to the mix prior to, during and after the addition of other mix ingredients, or during mixing, with a total fiber volume that is 1 to 100 times the volume of graphite nanoplatelets.

8. A method of producing a cementitious product with dispersed graphite nanoplatelets, the method comprising:
(a) Adding graphite nanoplatelets with 0.3 to 300 nanometer thickness and 3 to 300 micrometer planar dimensions to a mixer in wet, non-agglomerated state with 15 to 95% by weight of water molecules which occur in physically adsorbed state on the surfaces of said graphite nanoplatelets, and hinder their agglomeration via secondary bonding;
(b) Adding to said mixer water and hydraulic cement with a total volume that is 50 to times the solid volume of said graphite nanoplatelets, and with water-to-cement weight ratio of 0.1 to 0.9; and
(c) Mixing of water, hydraulic cement and graphite nanoplatelets at 3 to 300 rounds per minute rotational speed for 1 to 45 minutes to produce a fresh cementitious material with dispersed graphite nanoplatelets;
(d) Placing, consolidating and finishing of said fresh cementitious material with dispersed graphite nanoplatelets inside a mold;
(e) Curing the cementitious material with dispersed graphite nanoplatelets by preventing moisture loss at temperatures ranging from 5° C. to 250° C. over periods ranging from hour to 28 days.

9. The method of claim 8, wherein the mixer is one of planetary mixer, drum mixer, pan mixer, vertical axis mixer, and twin shaft mixer that is stationary or mixed on a vehicle, or a manual mixing method.

10. The method of claim 8, wherein consolidation of the fresh cementitious material with dispersed graphite nanoplatelets is accomplished via internal vibration, external vibration, force of gravity, and combinations thereof.

11. The method of claim 8, wherein finishing of the fresh cementitious material with dispersed graphite nanoplatelets is accomplished via screeding, troweling, floating, edging, broom finishing, and combinations thereof.

12. The method of claim 8, wherein the hydraulic cement is Portland cement, Portland-limestone cement, Portland-slag cement, Portland-pozzolan cement, ternary blended cement, general use cement, high early strength cement, moderate sulfate resistance cement, high sulfate resistance cement, moderate heat of hydration cement, low heat of hydration cement, masonry cement, calcium aluminate cement, calcium sulfoaluminate cement, aluminosilicate-based cement, shrinkage compensating cement, gypsum, lime, and combinations thereof.

13. The method of claim 8, wherein 5% to 75% by weight of hydraulic cement is replaced with coal ash, ground steel slag, silica fume, natural pozzolan, metakaolin, calcined clay, biomass ash, and combinations thereof.

14. The method of claim 8, wherein one or more additives selected from the group consisting of chemical additives, polymer additives, mineral additives and coloring additives is added to the mix prior to, during and after the addition of other mix ingredients, or during mixing.

15. The method of claim 8, wherein one or more aggregates selected from the group of fine aggregates with maximum particle size less than 4.75 mm and coarse aggregates with maximum particle size more than 4.75 mm is added to the mix prior to, during and after the addition of other mix ingredients, or during mixing, with a total aggregate weight that is 0.1 to times the weight of hydraulic cement.

16. The method of claim 8, wherein one or more fibers selected from the group consisting of steel, polymer, glass and carbon fibers with 0.1 to 5000 micrometer diameter and length-to-diameter ratio of 10 to 1000 is added to the mix prior to, during and after the addition of other mix ingredients, or during mixing, with a total fiber volume that is 1 to 100 times the volume of graphite nanoplatelets.

17. The method of claim 8, wherein the mold incorporates 0.25% to 10% by volume of reinforcing steel, prestressing steel, reinforcing composite, prestressing composite, and combinations thereof.

18. A blend of fresh cementitious paste and graphite nanoplatelets in a state that said nanoplatelets can be dispersed within the cementitious paste in a mixer with 3 to 300 rounds per minute rotational speed over 1 to 45 minutes, comprising:
(a) Graphite nanoplatelets with 0.3 to 300 nanometer thickness and 3 to 300 micrometer planar dimensions in wet, non-agglomerated state with 15 to 95% by weight of water molecules which occur in physically adsorbed state on the surfaces of said nanoplatelets, and hinder their agglomeration via secondary bonding; and
(b) Water and hydraulic cement with a total volume that is 50 to 5000 times the solid volume of said graphite nanoplatelets, and with water-to-cement weight ratio of 0.1 to 0.9.

19. The blend of fresh cementitious paste and graphite nanoplatelets of claim 18, wherein the mixer is one of planetary mixer, drum mixer, pan mixer, vertical axis mixer, and twin shaft mixer mixer that is stationary or mixed on a vehicle, or a manual mixing method.

20. The blend of fresh cementitious paste and graphite nanoplatelets of claim 18, wherein the hydraulic cement is Portland cement, Portland-limestone cement, Portland-slag cement, Portland-pozzolan cement, ternary blended cement, general use cement, high early strength cement, moderate sulfate resistance cement, high sulfate resistance cement, moderate heat of hydration cement, low heat of hydration cement, masonry cement, calcium aluminate cement, calcium sulfoaluminate cement, aluminosilicate-based cement, shrinkage compensating cement, gypsum, lime, and combinations thereof.

21. The blend of fresh cementitious paste and graphite nanoplatelets of claim 18, wherein 5% to 75% by weight of hydraulic cement is replaced with coal ash, ground steel slag, silica fume, natural pozzolan, metakaolin, calcined clay, biomass ash, and combinations thereof.

22. The blend of fresh cementitious paste and graphite nanoplatelets of claim 18, wherein one or more additives selected from the group consisting of chemical additives, polymer additives, mineral additives and coloring additives is added to the blend.

23. The blend of fresh cementitious paste and graphite nanoplatelets of claim 18, wherein one or more aggregates selected from the group of fine aggregates with maximum particle size less than 4.75 mm and coarse aggregates with maximum particle size more than 4.75 mm is added to the blend at a total aggregate weight that is 0.1 to 10 times the weight of hydraulic cement.

24. The blend of fresh cementitious paste and graphite nanoplatelets of claim 18, wherein one or more fibers selected from the group consisting of steel, polymer, glass and carbon fibers with 0.1 to 5000 micrometer diameter and length-to-diameter ratio of 10 to 1000 is added to the blend at a total fiber volume that is 1 to 100 times the volume of graphite nanoplatelets.
